(19) United States
(12) Patent Application Publication
(10) Pub. No.: US 2006/0130261 A1
(43) Pub. Date: Jun. 22, 2006

(54) Quick release paint roller assembly

(75) Inventors: Dennis M. Futo, Strongsville, OH (US); Scott A. Pyle, Vernon Hills, IL (US); Michael M. Sherman, Mooresville, NC (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Zibra, LLC, Mooresville, NC (US)

(21) Appl. No.: 11/064,473

(22) Filed: Feb. 23, 2005

Related U.S. Application Data
(60) Provisional application No. 60/638,449, filed on Dec. 22, 2004.

(51) Int. Cl. B05C 17/02

(52) U.S. Cl. 15/230.11; 492/13; 492/19

(57) ABSTRACT

A quick-release paint roller having a roller cover that can be removed from a handle assembly without requiring the user to apply a force directly to the roller cover. The paint roller includes a pair of end caps. The end caps have axial bores therein and are disposed at opposing ends of the roller tube. The inner end cap has a hub with a nipple extending there from, the nipple having a head portion and an annular groove between the head portion and the hub. The paint roller also includes a handle assembly. The handle assembly includes a housing having an opening configured to receive the nipple of the roller cover. The handle assembly also includes a roller support having an elongate shaft, the elongate shaft being received by the bores of the inner and outer end caps to rotatably support the roller cover about an axis of rotation along the elongate shaft. The handle assembly further includes a latching mechanism movable between a latched position and a release position, the latching mechanism including an actuator and a latch. When the actuator is in the latched position, movement of the roller cover in a direction along the axis of rotation away from the housing is prevented. The handle assembly also includes a latch spring for biasing the actuator toward the latched position, and an ejector spring acting upon the nipple, wherein the ejector spring urges the nipple out of the opening, wherein when the latch is free of the nipple, the ejector spring ejects the roller cover from the handle assembly.

### REFERENCE TO RELATED APPLICATION

The present application claims priority under 35 U.S.C. §119(e) to U.S. provisional patent application No. 60/638,449, filed Dec. 22, 2004.

### BACKGROUND OF THE INVENTION

1. Field of Invention

This invention relates a roller assembly for use in applying a coating to a surface, and more particularly, to a paint roller assembly.

2. Description of Related Art

It is known to use paint roller assemblies having a handle with a roller support and a rotatable roller cover to apply paint to a wall. Normally, the roller cover is removably mounted on the roller support so that the roller cover can be detached from the support after use and cleaned or replaced as desired. Additionally, the useful life of the roller cover is often quite limited when compared to that of the handle and roller support. As such, the roller cover is usually removed from the handle after each use.

Typically, roller covers are frictionally secured to the roller support. One disadvantage associated with this type of roller assembly, is that, in order to remove the roller cover from the roller support, it is usually necessary to grasp the outer surface of the roller cover and slide it off of the roller support. As the roller cover being removed is normally covered with wet paint, the process of removing the roller cover from the roller assembly can be messy and often leads to paint getting on the hands and clothes of the person removing the roller cover. If one waits until the paint on the roller cover dries before removing the cover, the paint between the roller cover and the roller support dries and seals the roller cover to the roller support. Thus, in order to remove the roller cover from the paint roller assembly it is sometimes necessary to break the dried paint away from the end caps of the roller support, thereby allowing the roller cover to be removed from the roller assembly. Alternatively, it may be necessary to slice, or cut the roller cover along a length thereof, allowing the roller cover to be peeled away from the roller assembly.

Based on the foregoing, it would be desirable to provide a paint roller assembly with a roller cover that can be removed quickly and easily without having to grasp or touch the paint-covered roller cover.

### SUMMARY OF INVENTIVE FEATURES

One embodiment of the invention is directed to a quick-release paint roller having a roller cover that can be removed from a handle assembly without requiring the user to apply a force directly to the roller cover. The paint roller includes a roller cover including a roller tube having an outer surface of paint absorbing material, an inner end cap and an outer end cap. The end caps have axial bores therein and are disposed at opposing ends of the roller tube. The inner end cap has a hub with a nipple extending there from, the nipple having a head portion and an annular groove between the head portion and the hub. The paint roller also includes a handle assembly. The handle assembly includes a housing having a first surface facing the inner end cap of the roller cover, wherein the housing has an opening in the first surface configured to receive the nipple of the roller cover. The handle assembly also includes a roller support having an elongate shaft, the elongate shaft being received by the bores of the inner and outer end caps to rotatably support the roller cover about an axis of rotation along the elongate shaft. The handle assembly further includes a latching mechanism movable between a latched position and a release position, the latching mechanism including an actuator and a latch. When the actuator is in the latched position, the latch engages the annular groove of the nipple to couple the roller cover to the handle assembly and prevent movement of the roller cover in a direction along the axis of rotation away from the housing, and when the actuator is in the release position, the latch is free of the nipple. The handle assembly also includes a latch spring for biasing the actuator toward the latched position, and an ejector spring acting upon the nipple, wherein the ejector spring urges the nipple out of the opening, wherein when the latch is free of the nipple, the ejector spring ejects the roller cover from the handle assembly, thereby permitting the roller cover to be removed from the handle assembly without requiring the user to apply a force directly to the roller cover.

In another embodiment, the invention is directed to a quick-release paint roller having a roller cover that can be removed from a handle assembly without requiring the user to apply a force directly to the roller cover. The paint roller includes a roller cover comprising a roller tube having an outer surface of paint absorbing material and an inner end cap having a nipple extending there from. The paint roller also includes a handle assembly. The handle assembly includes a housing and a roller support having an elongate shaft, the elongate shaft being received by roller cover rotatably mount the roller cover about an axis of rotation along the elongate shaft. The handle assembly also includes a latching mechanism movable between a latched position and a release position, the latching mechanism comprising an actuator and a latch, wherein when the actuator is in the latched position, the latch engages the nipple to couple the roller cover to the handle assembly and prevent movement of the roller cover in a direction along the axis of rotation away from the housing, and wherein when the actuator is in the release position, the latch is free of the nipple, wherein the actuator extends from the housing to form an actuating surface located on the handle assembly away from the axis of rotation of the roller cover to thereby permit the roller cover to be removed from the handle assembly without requiring the user to apply a force directly to the roller cover.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of a roller assembly;

FIG. 2A is a perspective view of an alternate embodiment of a roller assembly;

FIG. 2B is an enlarged perspective view of the roller assembly of FIG. 2A illustrating a quick-release feature of the roller assembly;

FIG. 3 is a cutaway view of a roller assembly of FIG. 2A illustrating the latching mechanism of the roller assembly;

FIG. 4 is a partly in section view of the roller cover of the roller assembly of FIG. 2A;

FIG. 5A is an enlarged side view of a trigger of the latching mechanism of the roller assembly of FIG. 2A;

FIG. 5B is an enlarged plan view of a trigger of the latching mechanism of the roller assembly of FIG. 2A; and

FIG. 6 is a cutaway view of a roller assembly of FIG. 1 illustrating the latching mechanism of the roller assembly.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

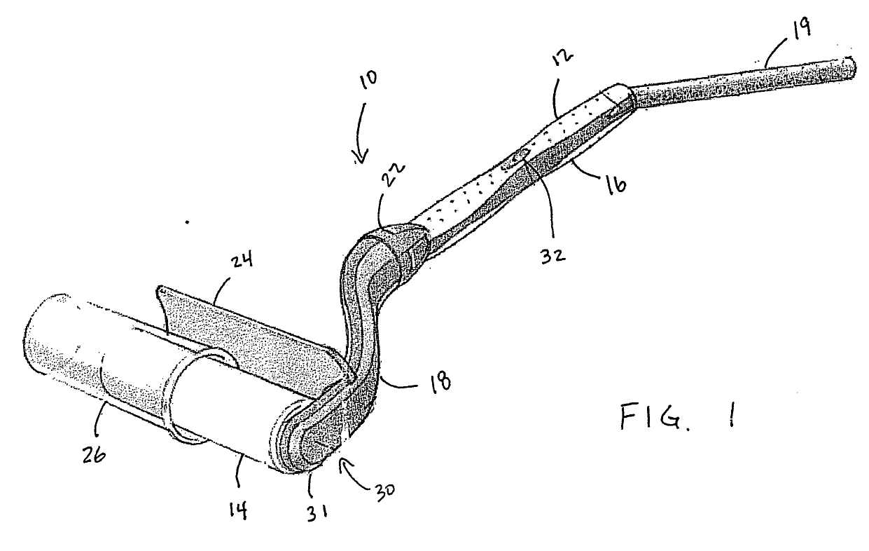

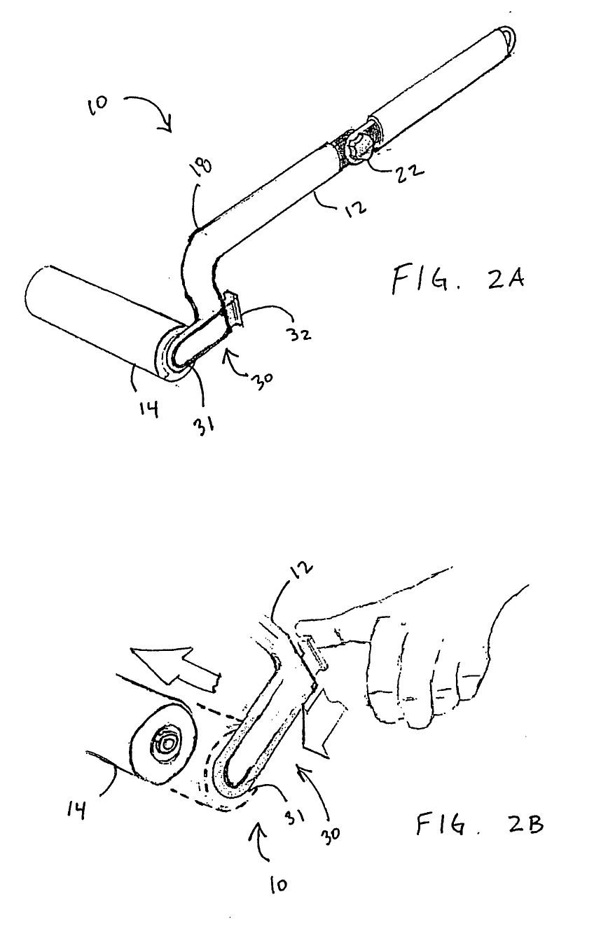

Referring now to FIGS. 1 and 2, the invention is directed to a roller tool assembly generally designated by the reference number 10 for use in applying paint or other product to a work surface. The paint roller 10 includes a handle assembly generally designated by the reference numeral 12 and a roller cover 14 rotatably coupled thereto. The handle assembly 12 includes a hand grip 16 useful for gripping the paint roller 10 and a generally S-shaped housing 18 attached to the hand grip 16 for rotatably latching the roller cover 14. Desirably, the hand grip 16 is a soft grip overmold ergonomic handle grip to improve comfort while in use. Alternatively, other hand grips known in the art may be used without departing from the scope of the invention. The hand grip 16 is secured to the housing 18 with a set screw 20. However, the invention is not limited in this regard, as other types of fasteners, such as adhesives or rivets could be utilized to attach the housing 18 to the hand grip 16, or the housing 18 can be manufactured integral to the hand grip 16.

The handle assembly 12 desirably has a length of about 18 inches for one or two handed use. In the embodiment illustrated in FIG. 1, a telescoping soft grip handle 19 slides out of the hand grip 16 for additional handle length for hard to reach areas. Accordingly, the total length this embodiment of the paint roller tool 10 is desirably between about 35 inches to about 45 inches during maximum extension mode. However, one skilled in the art will recognize that any handle length may be used without departing from the scope of the invention. Desirably, the handle assembly 12 also includes a multi-position lateral swivel feature 22 with lock detail for improved usage. While materials for the handle assembly 12 are not intended to be limiting, preferably the handle assembly 12 is manufactured of a material such as aluminum or plastic for providing a high performance and durable paint roller 10. An optional splash guard 24 may extend between the roller cover 14 and the hand grip 16 as is known in the art. Additionally, an optional snap-over roller saver 26 is provided whereby wet paint on the roller can be temporarily stored for short periods of time (i.e., a drying stage or until the next day).

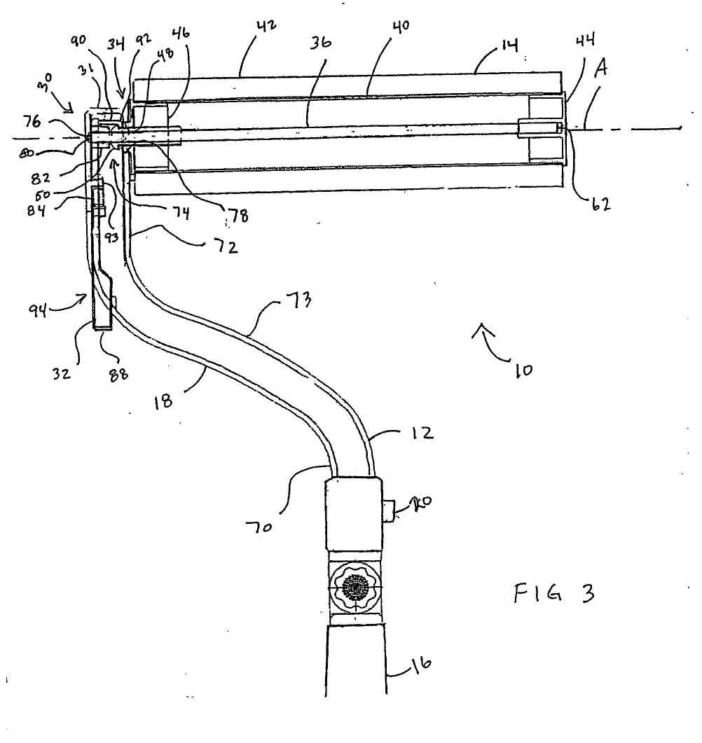

Referring now to FIGS. 1-3, according to the invention, the paint roller tool 10 includes a “hands-free” quick-release feature that quickly detaches the roller cover 14 from the handle assembly 12 through an internal latching mechanism 30 that extends from near the hand grip 16 area to a roller cover mounting end 31 of handle assembly 12. FIG. 1 illustrates the latching mechanism 30 comprising an actuator 32 in the form of a roller-eject slide switch, which, when actuated, causes the automatic releasing and ejection of the roller cover 14 to an extended position relative to the housing 18, to thereby at least partially decouple the roller cover 14 from the handle assembly 12. FIG. 2A illustrates the latching mechanism 30 with the actuator 32 in the form of a trigger which can be depressed as illustrated in FIG. 2B for actuating the quick-release feature. Although the embodiments in FIGS. 1 and 2 illustrate different methods for actuating the latching mechanism 30, and other means may be used using sound engineering judgment without departing from the scope of the invention, the resulting hands-free removal feature is substantially identical. As best seen in FIG. 3, the housing 18 of the handle assembly 12 includes a roller support, generally designated by the reference numeral 34, including a roller mounting shaft 36 on which the roller cover 14 is rotatably received. The mounting shaft 36 extends from the housing 18 along an axis A which is substantially coaxial with the axis of rotation of the roller cover 14. The axis A of the mounting shaft 36 is also generally perpendicular to the axis of the hand grip 16. Actuation of this quick-release feature automatically releases roller cover 14 thus eliminating the need for the user to have to handle the paint saturated roller cover 14 in order to remove the roller cover 14 from the handle assembly 12. The terms “automatic”, “hands-free” and “quick-release” as used herein with respect to the latching mechanism 30 mean that the decoupling of the paint roller cover 14 from the handle assembly 12 occurs without requiring the user to apply a manual force directly to the paint roller 10. In other words, although a force is required to be applied to the latching mechanism 30 to initiate the decoupling process, the actual force decoupling the roller from the handle assembly 12 is provided by means other than manual force applied by the user to the roller cover 14, as will be set forth more fully below.

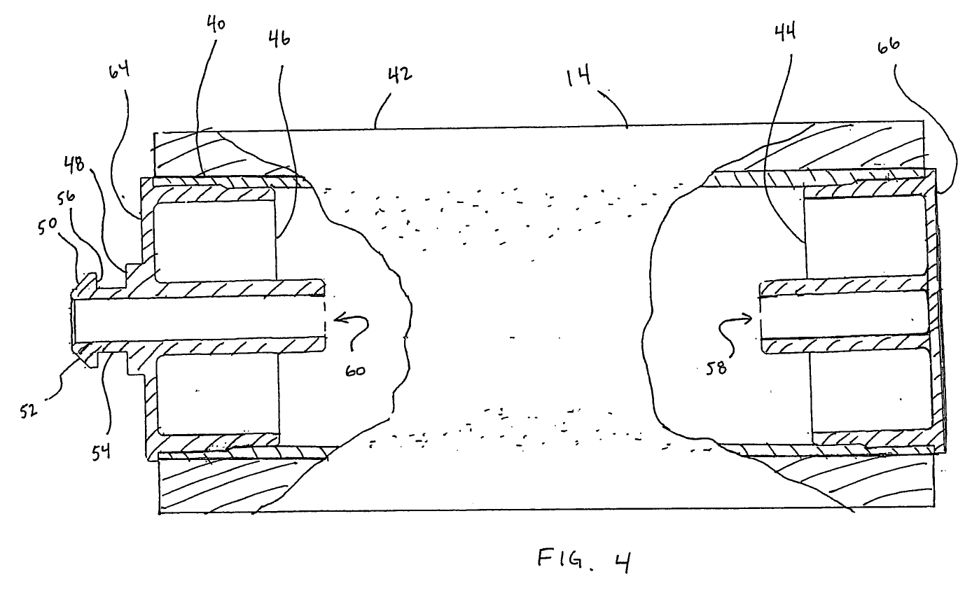

As best seen in the enlarged view of FIG. 4, the roller cover 14 includes a roller tube 40 with an outer circumferential surface material 42 for carrying paint or other material to be applied to the work surface. Desirably, the surface material 42 is made of sponge, cotton, synthetic fibers, wool or the like and is highly capable of absorbing the paint or other liquid to be applied. The roller cover 14 also has a pair of end caps, including an outer end cap 44 and an inner end cap 46 disposed and fitted in opposing ends of the roller tube 40. The inner end cap 46 comprises hub 48 having a nipple 50 extending there from generally along the rotational axis A of the roller cover 14. The nipple 50 has a rounded head 52 and an annular groove 54 around the base thereof forming a ridge surface 56. The outer end cap 44 and inner end cap 46 define axial bores 58, 60 respectively, sized to provide a bearing surface for rotation of the roller cover 14 about the mounting shaft 36 of the roller support 34 as illustrated in FIG. 3. The mounting shaft 36 is received through axial bore 60 in the inner end cap 46 and a distal end 62 of the mounting shaft 36 is received in the axial bore 58 in the outer end cap 44 for receiving the roller cover 14 on the roller support 34 of the handle assembly 12. Preferably, the inner and outer end caps 44, 46 are manufactured from a synthetic polymeric material, such as nylon or plastic, however, other materials could also be used. As shown in FIG. 3, the inner and outer end caps 44, 46 include a cap face 64, 66 for preventing paint from entering the hollow interior of the roller cover 14. The diameter of the end face 64, 66 is larger than the diameter of the portion of the end cap 44, 46 for engaging the roller tube 40 of the roller cover 14. The roller cover 14 desirably has a width and a diameter substantially equally to those of a standard 9-inch roller. However, other widths, such as 4 inches, and diameters may be used without departing from the scope of the invention.

As best seen in FIG. 3, the housing 18 is desirably a generally elongated tubular member having a generally S-shape such that a first leg 70 is generally aligned with the hand grip 16 and a second leg 72 is parallel to the first leg 70 but offset such that the hand grip 16 is positioned along an axis extending from or near the midpoint of the roller cover 14. A midsection 73 joins the first leg 70 and second leg 72 to form the generally S-shaped housing 18. The housing 18 forms a channel 74 which is defined by the interior surfaces of the housing 18. The roller mounting shaft 36 has an end portion 76 disposed in a bore 78 in the housing 18 leading to the channel 74 and is attached to the housing 18 with a screw 80 or other fastening device. The channel 74 is also adapted to receive at least a portion of the latching mechanism 30 and the nipple 50 of the roller cover 14 as described below.

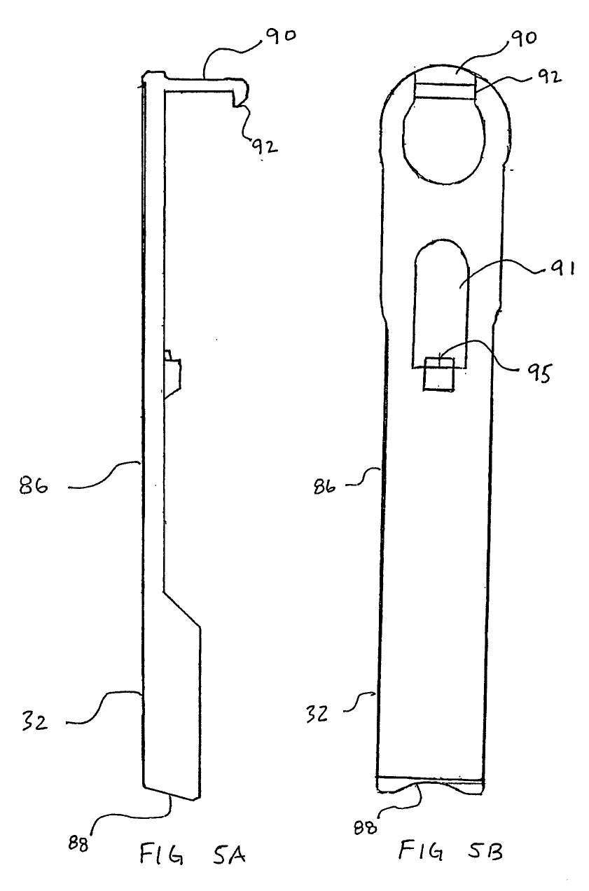

In the embodiment illustrated in FIGS. 2 and 3, the latching mechanism 30 includes the trigger 32, an ejector spring 82 and a latch spring 84. As best seen in FIGS. 5A and 5B, the trigger 32 includes an elongate body 86 having an actuating surface 88 at a proximal end and a latch 90 protruding from a distal end thereof. The latch 90 includes a detent 92 at the outer end thereof. In the latched condition, as depicted in FIG. 3, the latch 90 engages the nipple 50 of the inner end cap 46 to secure the roller cover 14 on the roller support 34. The detent 92 fits into the annular groove 54 and contact with the ridge 56 on the nipple 50 prevents movement of the roller cover 14 in the outward direction along the axis of rotation A of the roller cover 14. The trigger 32 is partially disposed inside the housing 18 such that the actuating surface 88 extends outwardly from an opening 94 in the housing 18 so that it can be pushed by the user to automatically uncouple the roller cover 14 as depicted in FIG. 2B.

The latch spring 84 is disposed in the chamber 74 of the housing 18 and urges the trigger 32 toward a neutral position. Desirably, the neutral position of the trigger 32 is the latched condition illustrated in FIG. 3. As best seen in FIG. 5B, in one embodiment, the body 86 of the trigger 32 has a window 91 formed therein and the latch spring 84 is positioned within this window. As illustrated in FIG. 3, the latch spring is retained in the window 91 with one end of the latch spring received on a nub 95 formed on the body 86. The other end of the latch spring contacts a protrusion 93 extending from the inner wall of the housing 18 protruding through the window 91. In the neutral position shown, the latch spring 84 exerts a force on the trigger 32 causing the detent 92 to engage the annular groove 54 in order to retain the roller cover 14. The roller cover 14 is released by the latching mechanism 30 by applying a force on the trigger 32 to overcome the force of the latching spring 84 and move the trigger into a release position wherein the detent 92 moves out of the annular groove 54 so that the latch 90 is free of the nipple 50.

The ejector spring 82 is disposed between the body 86 of the trigger 32 and the head 52 of the nipple 50. The ejector spring 82 is biased to urge the nipple 50 out of the chamber 74 of the housing 18 so as to eject the roller cover 14. However, as long as the trigger 32 is in the latched condition, the latch 90 retains the nipple 50 in the housing 18 against the bias of the ejector spring 82 and the roller cover 14 remains on the roller support 34. When the trigger 32 is actuated and the detent 92 clears the ridge 56 on the nipple 50, the ejector spring 82 forces the nipple 50 out of the housing 18 and thus decouples the roller cover 14 from of the latching mechanism 30 so that the roller cover 14 can freely slide off the mounting shaft 36. Desirably, the hub 48 of the inner end cap 46 has a diameter only slightly smaller than the diameter of the bore 78 in the housing 18. Thus, when the roller cover 14 is in the latched condition, the hub 48 is received within the bore 78 in the housing 18 and forms a frictional fit that discourages paint from entering into the chamber 74 of the housing 18.

To mount a roller cover 14 to the handle assembly 12, the roller cover 14 is slide onto the roller support 34 by inserting the mounting shaft 36 through the axial bores 58, 60 in the end caps 44, 46. The nipple 50 on the inner end cap 46 is then inserted into the bore 78 in the housing 18. The rounded head 52 of the nipple contacts the detent 92 on the trigger 32 causing the latch 90 to move upwards against the biasing force of the latching spring 84. When the detent 92 passes the head 52, it snaps into the annular groove 54. Thus, contact of the latch 90 against the ridge 56 of the nipple 50 keeps the roller cover 14 from leaving the roller support 34, yet permits the roller cover 14 to freely rotate on the mounting shaft 36 in order to apply the paint to the work surface. When it is desired to remove the roller cover 14 from the handle assembly 12, the user simply presses on the actuating surface 88 of the trigger 32 and urges the trigger against the spring force provided by the latch spring 84. This causes the latch 90 to move toward the end 31 of the housing 18 until the detent 92 clears the ridge 56 on the nipple 50 of the roller cover 14. When the detent 92 clears the ridge 56, the ejector spring 82 forces the nipple 50 out of the bore 78 in the housing 18 and the roller cover 14 is free to slide off the roller support 34. Therefore, pressing on the trigger 32 automatically ejects the roller cover 14 from the handle assembly 12 without requiring the user to come in contact with the wet paint covering the roller cover 14. Desirably, the nipple 50 allows the roller cover 14 to quickly be removed from the handle assembly 12 after only depressing the trigger 32 for the time required for the detent 92 to pass over the ridge 56 of the nipple 50.

Importantly, it is desirable that the actuating surface 88 of the trigger 32 be a sufficient distance from the end 31 of the housing 18 to reduce the likelihood that the actuating surface will be covered by paint. Paint rollers 10 are typically used by dipping the roller cover 14 into a tray filled with the paint to be applied to the work surface. As such, the end 31 of the housing 18 also may also come in contact with and be covered by the paint from the tray. Thus, the actuating surface 88 is desirably offset from the axis A of the roller cover 14 and mounting shaft 36 to position the actuating surface in a location that will not routinely come in contact with the paint. In the embodiment illustrated in FIG. 3, the actuating surface 88 of the trigger extends from the end of the second leg 72 of the S-shape of the housing 18 so that the actuating surface 88 is located in the region of the handle assembly 12 occupied by the midsection 73 of the housing 18. Thus, the actuating surface 88 is offset from the axis A by a distance of several inches, which is desirably at least 2 inches and more desirably at least 4 inches.

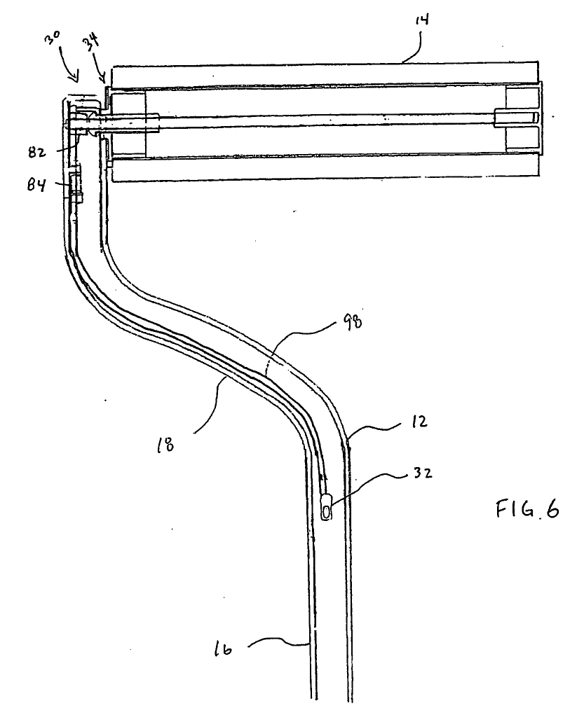

Turning now to FIG. 6, another embodiment of the paint roller 10 is illustrated. In this embodiment, the actuator 32 of the latching mechanism 30 is a roller-eject slide switch as depicted in FIG. 1. The slide switch 32 is connected to a solid spring-loaded shaft 98 that extends to the latch 90 internal to the housing 18. In this manner, the actuator is located proximate the hand grip 16 of the handle assembly 12. Sliding the slide switch 32 forward along the handle assembly 12 against a biasing force of the latch spring 84 causes the latching mechanism 30 to unlatch and eject the roller cover 14 as described above.

The outer and inner end caps 44, 46 of the invention can be removed from the roller cover 14 and reused by simply inserting the end caps in the opposing ends of a new roller cover 14. Alternatively, a roller cover 14 can have the end caps 44, 46 manufactured integral thereto or provided therewith. Further, the end caps 44, 46 could be made separately available for modifying a standard roller cover 14 to be used with the handle assembly 12 of the present invention.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A quick-release paint roller comprising:
a roller cover comprising a roller tube having an outer surface of paint absorbing material, an inner end cap and an outer end cap, the end caps having axial bores therein and being disposed at opposing ends of the roller tube, wherein the inner end cap has a hub with a nipple extending there from, said nipple having a head portion and an annular groove between the head portion and the hub;
a handle assembly comprising:
a housing having a first surface facing the inner end cap of the roller cover, wherein the housing has an opening in the first surface configured to receive the nipple of the roller cover;
a roller support having an elongate shaft, said elongate shaft being received by the bores of the inner and outer end caps to rotatably support the roller cover about an axis of rotation along said elongate shaft;
a latching mechanism movable between a latched position and a release position, said latching mechanism comprising an actuator and a latch, wherein when the actuator is in the latched position, the latch engages the annular groove of the nipple to couple the roller cover to the handle assembly and prevent movement of the roller cover in a direction along the axis of rotation away from the housing, and wherein when the actuator is in the release position, the latch is free of the nipple;
a latch spring for biasing the actuator toward the latched position; and
an ejector spring acting upon the nipple, wherein the ejector spring urges the nipple out of the opening, wherein when the latch is free of the nipple, the ejector spring ejects the roller cover from the handle assembly, thereby permitting the roller cover to be removed from the handle assembly without requiring the user to apply a force directly to the roller cover.

2. The paint roller as defined in claim 1 wherein the actuator is a trigger having an elongate body, and wherein said latch protrudes from a distal end of said body and a proximal end of the body extends from an opening the housing and forms an actuating surface, such that a force applied to the actuating surface moves said actuator between the latched position and release position so as to remove said roller cover from the handle assembly.

3. The paint roller as defined in claim 2 wherein the actuator is offset from the axis of rotation of the roller cover by at least two inches.

4. The paint roller as defined in claim 3 wherein the housing is an elongate tubular member having an S-shape.

5. The paint roller as defined in claim 4 wherein the S-shaped housing has a first leg and a second leg, said second leg parallel to and offset from said first leg, said first and second legs being connected via a midsection, and wherein the trigger extends from the housing at an end of the second leg, said end being the end of the second leg closer to the first leg of the housing.

6. The paint roller as defined in claim 2 wherein the trigger has a window formed in the elongate body, and wherein said latching spring is positioned on said trigger within said window such that one end of the spring abuts a protrusion on the housing such that the latching spring exerts a spring force on the trigger to urge the trigger into the latched position, and wherein a force applied to the trigger compresses the latching spring to move the trigger into the release position.

7. The paint roller as defined in claim 1 wherein the actuator is a slide switch mounted on the housing and connected to a shaft positioned inside the housing, said shaft extending from the slide switch to the latch coupling the roller cover to the handle assembly.

8. The paint roller as defined in claim 7 wherein the slide switch is mounted adjacent a hand grip on the handle assembly.

9. A quick-release paint roller comprising:
a roller cover comprising a roller tube having an outer surface of paint absorbing material and an inner end cap having a nipple extending there from;
a handle assembly comprising:
a housing;
a roller support having an elongate shaft, said elongate shaft being received by roller cover rotatably mount the roller cover about an axis of rotation along said elongate shaft;
a latching mechanism movable between a latched position and a release position, said latching mechanism comprising an actuator and a latch, wherein when the actuator is in the latched position, the latch engages the nipple to couple the roller cover to the handle assembly and prevent movement of the roller cover in a direction along the axis of rotation away from the housing, and wherein when the actuator is in the release position, the latch is free of the nipple;
a latch spring for biasing the actuator toward the latched position; and
an ejector spring acting upon the roller cover to urge the roller cover off of the elongate shaft of the roller support, wherein when the latch is free of the nipple, the ejector spring ejects the roller cover from the handle assembly, thereby permitting the roller cover to be removed from the handle assembly without requiring the user to apply a force directly to the roller cover.

10. The paint roller as defined in claim 9 wherein the roller cover has an inner end cap and an outer end cap, said end caps having axial bores therein and being disposed at opposing ends of the roller tube, wherein the elongate shaft of the roller support is received by the bores of the inner and outer end caps to rotatably support the roller cover.

11. The paint roller as defined in claim 9 wherein the nipple has a head portion and an annular groove located between the head portion and inner end cap, and wherein the latch engages the annular groove of the nipple to couple the roller cover to the handle assembly and prevent movement of the roller cover in a direction along the axis of rotation away from the housing.

12. The paint roller as defined in claim 9 wherein the ejector spring acts upon the nipple of the roller cover.

13. The paint roller as defined in claim 9 wherein the housing has a first surface facing the inner end cap of the roller cover, wherein the housing has an opening in the first surface configured to receive the nipple of the roller cover.

14. The paint roller as defined in claim 9 wherein the actuator is a trigger having an elongate body, and wherein said latch protrudes from a distal end of said body and a proximal end of the body extends from an opening the housing and forms an actuating surface, such that a force applied to the actuating surface moves said actuator between the latched position and release position so as to remove said roller cover from the handle assembly.

15. The paint roller as defined in claim 14 wherein the actuator is offset from the axis of rotation of the roller cover by at least two inches.

16. The paint roller as defined in claim 14 wherein the housing is an elongate tubular member having a first leg and a second leg, said second leg parallel to and offset from said first leg, said first and second legs being connected via a midsection to form an S-shape, and wherein the trigger extends from the housing at an end of the second leg, said end being the end of the second leg closer to the first leg of the housing.

17. The paint roller as defined in claim 9 wherein the actuator is a slide switch mounted on the housing and connected to a shaft positioned inside the housing, said shaft extending from the slide switch to the latch coupling the roller cover to the handle assembly.

18. The paint roller as defined in claim 17 wherein the slide switch is mounted adjacent a hand grip on the handle assembly.

19. A quick-release paint roller comprising:
a roller cover comprising a roller tube having an outer surface of paint absorbing material and an inner end cap having a nipple extending there from;
a handle assembly comprising:
a housing;
a roller support having an elongate shaft, said elongate shaft being received by roller cover rotatably mount the roller cover about an axis of rotation along said elongate shaft;
a latching mechanism movable between a latched position and a release position, said latching mechanism comprising an actuator and a latch, wherein when the actuator is in the latched position, the latch engages the nipple to couple the roller cover to the handle assembly and prevent movement of the roller cover in a direction along the axis of rotation away from the housing, and wherein when the actuator is in the release position, the latch is free of the nipple, wherein the actuator extends from the housing to form an actuating surface located on the handle assembly away from the axis of rotation of the roller cover to thereby permit the roller cover to be removed from the handle assembly without requiring the user to apply a force directly to the roller cover.

20. The paint roller as defined in claim 19 further comprising a latch spring for biasing the actuator toward the latched position and an ejector spring acting upon the roller cover to urge the roller cover off of the elongate shaft of the roller support, wherein when the latch is free of the nipple, the ejector spring ejects the roller cover from the handle assembly, thereby permitting the roller cover to be removed from the handle assembly without requiring the user to apply a force directly to the roller cover.
